(19) United States
(12) Patent Application Publication
(10) Pub. No.: US 2026/0122587 A1
(43) Pub. Date: Apr. 30, 2026

(54) MULTIPLEXING BETWEEN ALWAYS-ON AND ON-DEMAND SSBs

(71) Applicant: Samsung Electronics Co., Ltd., Suwon-si, Gyeonggi-do (KR)

(72) Inventor: Hongbo Si, Allen, TX (US)

(21) Appl. No.: 19/353,561

(22) Filed: Oct. 8, 2025

Related U.S. Application Data
(60) Provisional application No. 63/713,865, filed on Oct. 30, 2024.
(60) Provisional application No. 63/764,137, filed on Feb. 27, 2025.

(51) Int. Cl. H04W 56/00

(52) U.S. Cl. CPC H04W 56/001

(57) ABSTRACT

Apparatuses and methods for multiplexing between always-on and on-demand synchronization signal blocks (SSBs). A method includes receiving a set of higher layer parameters, determining, based on the set of higher layer parameters, configurations for first and second sets of synchronization signals and physical broadcast channel (SS/PBCH) blocks, and identifying, based on the configurations, first and second frequency locations for the first and second sets of SS/PBCH blocks, respectively. The method further includes determining that the first set of SS/PBCH blocks is associated with a system information block 1 (SIB1), the first frequency location corresponds to a global synchronization channel number (GSCN) of an entry from a set of synchronization raster entries, the second set of SS/PBCH blocks is not associated with the SIB1, and the second frequency location does not correspond to a GSCN of any synchronization raster entry from the set of synchronization raster entries.

### CROSS-REFERENCE TO RELATED AND CLAIM OF PRIORITY

The present application claims priority under 35 U.S.C. § 119(e) to U.S. Provisional Ser. No. 63/713,865 filed on Oct. 30, 2024 and U.S. Provisional Ser. No. 63/764,137 filed on Feb. 27, 2025, which are hereby incorporated by reference in their entirety.

### TECHNICAL FIELD

The present disclosure relates generally to wireless communication systems and, more specifically, the present disclosure is related to apparatuses and methods for multiplexing between always-on and on-demand synchronization signal blocks (SSBs).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to multiplexing between always-on SSBs and on-demand SSBs.

In one embodiment, a user equipment (UE) in a wireless communication system is provided. The UE includes a transceiver configured to receive a set of higher layer parameters and a processor operably coupled to the transceiver. The processor is configured to determine, based on the set of higher layer parameters, configurations for first and second sets of synchronization signals and physical broadcast channel (SS/PBCH) blocks and identify, based on the configurations, a first frequency location for the first set of SS/PBCH blocks and a second frequency location for the second set of SS/PBCH blocks. The processor is further configured to determine that the first set of SS/PBCH blocks is associated with a system information block 1 (SIB1), the first frequency location corresponds to a first global synchronization channel number (GSCN) of a first synchronization raster entry from a set of synchronization raster entries, the second set of SS/PBCH blocks is not associated with the SIB1, the second frequency location is different from the first frequency location, and the second frequency location does not correspond to a second GSCN of any synchronization raster entry from the set of synchronization raster entries. The transceiver is further configured to receive the first and second sets of SS/PBCH blocks.

In another embodiment, a base station (BS) in a wireless communication system is provided. The BS includes a processor configured to determine configurations for first and second sets of SS/PBCH blocks that include a first frequency location for the first set of SS/PBCH blocks and a second frequency location for the second set of SS/PBCH blocks and determine that the first set of SS/PBCH blocks is associated with a SIB1, the first frequency location corresponds to a first GSCN of a first synchronization raster entry from a set of synchronization raster entries, the second set of SS/PBCH blocks is not associated with the SIB1, the second frequency location is different from the first frequency location, and the second frequency location does not correspond to a second GSCN of any synchronization raster entry from the set of synchronization raster entries. The BS further includes a transceiver operably coupled to the processor. The transceiver is configured to transmit a set of higher layer parameters including the configurations and transmit the first and second sets of SS/PBCH blocks.

In yet another embodiment, a method of a UE in a wireless communication system is provided. The method includes receiving a set of higher layer parameters, determining, based on the set of higher layer parameters, configurations for first and second sets of SS/PBCH blocks, and identifying, based on the configurations, a first frequency location for the first set of SS/PBCH blocks and a second frequency location for the second set of SS/PBCH blocks. The method further includes determining that the first set of SS/PBCH blocks is associated with a SIB1, the first frequency location corresponds to a first GSCN of a first synchronization raster entry from a set of synchronization raster entries, the second set of SS/PBCH blocks is not associated with the SIB1, the second frequency location is different from the first frequency location, and the second frequency location does not correspond to a second GSCN of any synchronization raster entry from the set of synchronization raster entries. The method further includes receiving the first and second sets of SS/PBCH blocks.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates examples of on-demand (OD)-SSBs and always-on (AO)-SSBs according to embodiments of the present disclosure;

FIG. 6 illustrates examples of OD-SSBs and AO-SSBs according to embodiments of the present disclosure;

FIG. 7 illustrates examples of OD-SSBs and AO-SSBs according to embodiments of the present disclosure;

FIG. 8 illustrates examples of OD-SSBs and AO-SSBs according to embodiments of the present disclosure;

FIG. 9 illustrates examples of OD-SSBs and AO-SSBs according to embodiments of the present disclosure;

FIG. 10 illustrates examples of OD-SSBs and AO-SSBs according to embodiments of the present disclosure; and

FIG. 11 illustrates a flowchart of an example UE procedure for receiving OD-SSB according to embodiments of the present disclosure.

### DETAILED DESCRIPTION

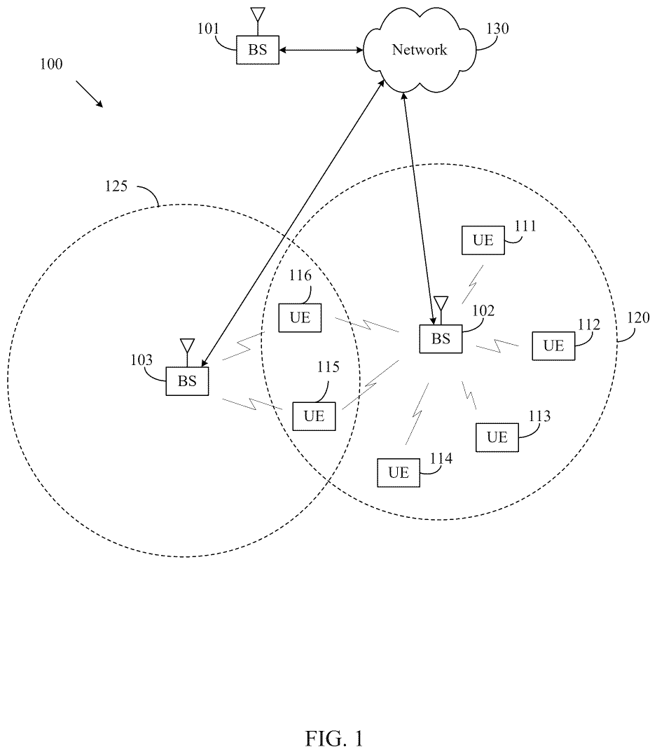

FIGS. 1-11 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v17.1.0, “NR; Physical channels and modulation;” [REF 2] 3GPP TS 38.212 v17.1.0, “NR; Multiplexing and channel coding;” [REF 3] 3GPP TS 38.213 v17.1.0, “NR; Physical layer procedures for control;” [REF 4] 3GPP TS 38.214 v17.1.0, “NR; Physical layer procedures for data;” and [REF 5] 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing multiplexing between always-on and on-demand SSBs. In certain embodiments, one or more of the BSs 101-103 include circuitry, programing, or a combination thereof to support multiplexing between always-on and on-demand SSBs.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

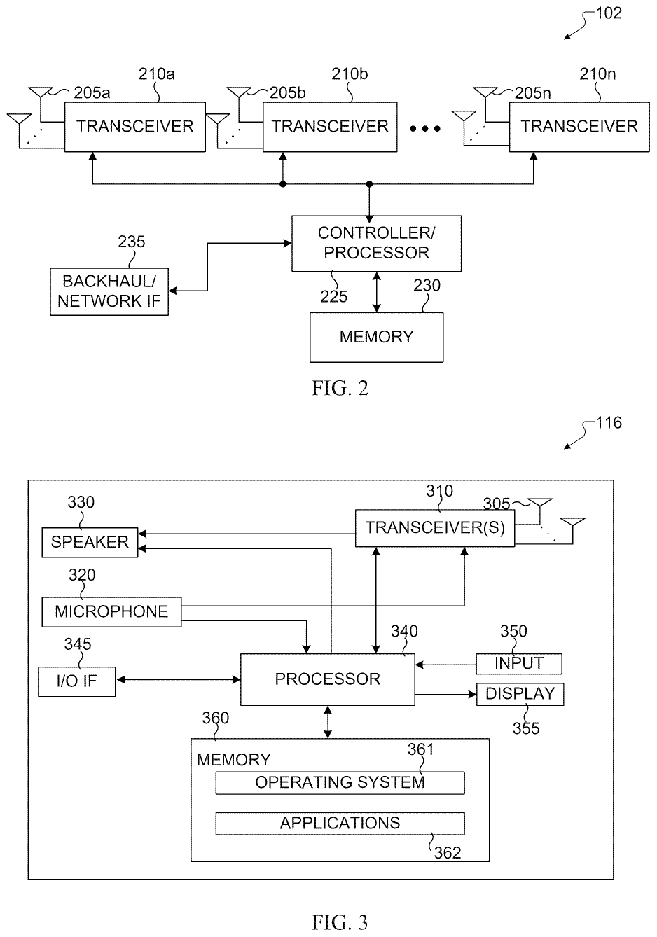

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for multiplexing between always-on and on-demand SSBs. Any of a wide variety of other functions could be supported in the gNB 102 by the controller/processor 225.

The controller/processor 225 is also capable of executing programs and other processes resident in the memory 230, such as processes to support multiplexing between always-on and on-demand SSBs. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing multiplexing between always-on and on-demand SSBs as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

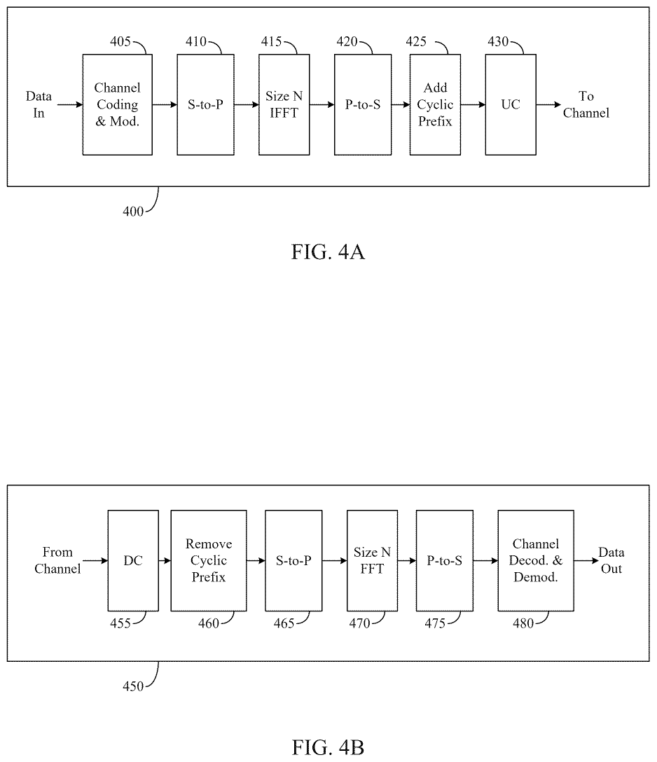

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured for multiplexing between always-on and on-demand SSBs as described in embodiments of the present disclosure. In some embodiments, the receive path 450 is configured for receiving multiplexed always-on and on-demand SSBs as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In NR, a cell can be configured with SS/PBCH block (SSB) transmissions, wherein the transmissions are in a periodic manner and the periodicity of the SSB is configured by the gNB (e.g., the BS 102). For initial access procedure, e.g., the UE is not provided with the configuration of the periodicity of the SSB yet, the UE can assume the periodicity for the SSB transmission is 20 ms. After initial access procedure, the UE can acquire the configuration of the periodicity for the SSB transmission, and assume the SSB transmission following the configured periodicity. The UE may not expect the periodicity for the SSB transmission varies if no reconfiguration of the parameter is provided to the UE.

Embodiments on the present disclosure recognizes that the periodic transmission of SSB (e.g., always-on SSB, or referred to as a first set of SSBs) using a configured periodicity may result in high energy consumption from the network perspective. For this, on-demand SSB transmission (e.g., referred to as a second set of SSBs) on top of or instead of always-on SSB can be supported, wherein the on-demand SSB can be indicated or configured or predetermined to be transmitted by the BS or requested by the UE, and/or may be confined within a period for its transmission. This disclosure provides multiplexing between the on-demand SSB and always-on SSB, including how to allocate resources for on-demand SSB based on always-on SSB.

For the remaining of this disclosure, always-on SSB or periodic SSB can be denoted as AO-SSB, and on-demand SSB or not periodic SSB can be denoted as OD-SSB.

For one example, the on-demand SSB can be applicable for RRC_CONNECTED mode.

For another example, the on-demand SSB can be applicable for RRC_IDLE mode.

For yet another example, the on-demand SSB can be applicable for RRC_INACTIVE mode.

For one example, the on-demand SSB can be applicable for a PCell.

For another example, the on-demand SSB can be applicable for a SCell.

For yet another example, the on-demand SSB can be applicable for a PSCell.

For one example, the on-demand SSB can be applicable for SSB as cell-defining SSB (e.g., with associated SIB1 transmission, such that a UE can utilize the SSB for SIB1 reception).

For another example, the on-demand SSB can be applicable for SSB as non-cell-defining SSB (e.g., without associated SIB1 transmission, such that a UE may not utilize the SSB for SIB1 reception).

For yet another example, the type of the on-demand SSB (e.g., cell-defining or non-cell-defining) is same as the type of always-on SSB in the same cell (if configured), e.g., both of on-demand SSB and always-on SSB are cell-defining SSB, or both of on-demand SSB and always-on SSB are non-cell-defining SSB.

For one example, the on-demand SSB can be applicable for SSB located at a frequency layer given by a synchronization raster entry.

For another example, the on-demand SSB can be applicable for SSB located at a frequency layer not given by a synchronization raster entry.

For one example, this disclosure can be applicable at least for the case that a cell is configured with always-on SSB transmission, and further configured with an on-demand SSB transmission in the same cell.

This disclosure includes multiplexing between always-on SSB and on-demand SSB in the same cell. More precisely, the following aspects are included in the disclosure:
Always-on SSB and on-demand SSB are located on the same frequency layer
   Both of them are located on the same sync raster
   Both of them are located on the same non sync raster
Always-on SSB and on-demand SSB are located on different frequency layers
   Always-on SSB is on sync raster, on-demand SSB is on non sync raster
   Always-on SSB is on non sync raster, on-demand SSB is on sync raster
   Always-on SSB and on-demand SSB are on different sync rasters
   Always-on SSB and on-demand SSB are on different non sync rasters
Example UE procedure

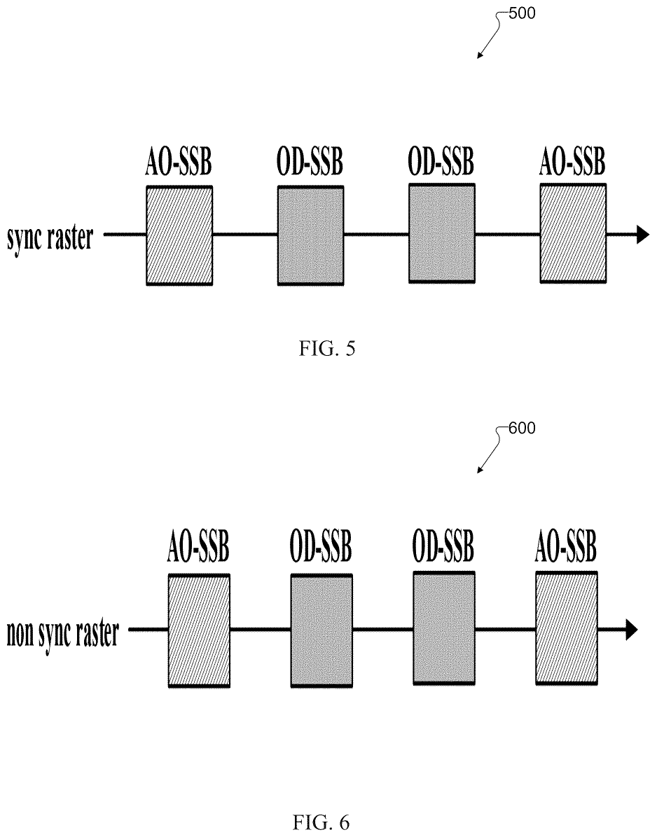

FIG. 5 illustrates examples of OD-SSBs and AO-SSBs 500 according to embodiments of the present disclosure. For example, OD-SSBs and AO-SSBs 500 can be received by any of the UEs 111-116 of FIG. 1, such as the UE 111. This example is for illustration only and other embodiments can be used without departing from the scope of the present disclosure.

In one embodiment, center frequencies of always-on SS/PBCH block (AO-SSB) and on-demand SSB (OD-SSB) can be located on the same frequency layer, wherein the frequency layer corresponds to a synchronization raster entry (e.g., defined by a global synchronization channel number, GSCN).

An illustration of the embodiment is shown in FIG. 5.

For one example, for this embodiment, the configuration of OD-SSB may not include a parameter indicating the frequency location of the OD-SSB, and it can share the same frequency location as the AO-SSB. For instance, the absence of the parameter indicating the frequency location of the OD-SSB may imply that the frequency location of the OD-SSB is same as the frequency location of the AO-SSB, when the AO-SSB is configured in the cell.

For another example, for this embodiment, the AO-SSB and OD-SSB have the same case of the SSB pattern in a half frame (e.g., predefined starting symbols for candidate SSB in a half frame).

For yet another example, for this embodiment, the AO-SSB and OD-SSB are located within a same BWP (e.g., active BWP), e.g., frequency resources of AO-SSB and OD-SSB are both included in the BWP.

For yet another example, for this embodiment, a UE (e.g., the UE 116) is not required to measure both AO-SSB and OD-SSB, wherein the measurement can be at least one of a layer 1 measurement or a layer 3 measurement.
For one further evaluation, this example can be applicable when the union of AO-SSB and OD-SSB is not a periodic pattern (e.g., intervals between two consecutive SSBs are not even), e.g., during the duration where both AO-SSB and OB-SSB are transmitted.

For one example, the AO-SSB can be a cell-defining SS/PBCH block (CD-SSB) (e.g., the SSB is associated with SIB1 transmission), and the OD-SSB can be a CD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in master information block (MIB) or physical broadcast channel (PBCH) payload (e.g., when they are in the same transmission time interval (TTI) of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6},ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index.
For yet another instance, the example can be applicable when the AO-SSB and OD-SSB have the same value of k_SSB.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if REs of one OD-SSB are same as REs of one AO-SSB (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For another example, the AO-SSB can be a cell-defining SS/PBCH block (CD-SSB) (e.g., the SSB is associated with SIB1 transmission), and the OD-SSB can be a non-cell-defining SS/PBCH block (NCD-SSB) (e.g., the SSB is not associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6},ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if REs of one OD-SSB are same as REs of one AO-SSB (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For yet another example, the AO-SSB can be a non-cell-defining SS/PBCH block (NCD-SSB) (e.g., the SSB is not associated with SIB1 transmission), and the OD-SSB can be a cell-defining SS/PBCH block (CD-SSB) (e.g., the SSB is associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6},ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if REs of one OD-SSB are same as REs of one AO-SSB (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE (e.g., the UE 116) can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For yet another example, the AO-SSB can be a non-cell-defining SS/PBCH block (NCD-SSB) (e.g., the SSB is not associated with SIB1 transmission), and the OD-SSB can be a NCD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6},ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index.
For yet another instance, the example can be applicable when the information for the CD-SSB indicated by controlResourceSetZero, searchSpaceZero, and k_SSB is same between the AO-SSB and OD-SSB.
For yet another instance, the example can be applicable when k_SSB is same between the AO-SSB and OD-SSB.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if REs of one OD-SSB are same as REs of one AO-SSB (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.
For yet another instance, this example can be applicable when AO-SSB is used for indicating information about another CD-SSB, and OD-SSB can be configured on top of the AO-SSB transmission on the same frequency layer, such that the reception and/or measurement based on the AO-SSB or OD-SSB can be faster. In addition, when the cell with AO-SSB is configured as a SCell, the OD-SSB can facilitate faster SCell activation.

FIG. 6 illustrates examples of OD-SSBs and AO-SSBs 600 according to embodiments of the present disclosure. For example, OD-SSBs and AO-SSBs 600 can be received by any of the UEs 111-116 of FIG. 1, such as the UE 112. This example is for illustration only and other embodiments can be used without departing from the scope of the present disclosure.

In one embodiment, center frequencies of always-on SS/PBCH block (AO-SSB) and on-demand SSB (OD-SSB) can be located on the same frequency layer, wherein the frequency layer does not correspond to a synchronization raster entry (e.g., defined by a global synchronization channel number, GSCN).

An illustration of the embodiment is shown in FIG. 6.

For one example, for this embodiment, the configuration of OD-SSB may not include a parameter indicating the frequency location of the OD-SSB, and it can share the same frequency location as the AO-SSB. For instance, the absence of the parameter indicating the frequency location of the OD-SSB may imply that the frequency location of the OD-SSB is same as the frequency location of the AO-SSB, when the AO-SSB is configured in the cell.

For another example, for this embodiment, the AO-SSB and OD-SSB have the same case of the SSB pattern in a half frame (e.g., predefined starting symbols for candidate SSB in a half frame).

For yet another example, for this embodiment, the AO-SSB and OD-SSB are located within a same BWP (e.g., active BWP), e.g., frequency resources of AO-SSB and OD-SSB are both included in the BWP.

For yet another example, for this embodiment, a UE is not required to measure both AO-SSB and OD-SSB, wherein the measurement can be at least one of a layer 1 measurement or a layer 3 measurement.
For one further evaluation, this example can be applicable when the union of AO-SSB and OD-SSB is not a periodic pattern (e.g., intervals between two consecutive SSBs are not even), e.g., during the duration where both AO-SSB and OB-SSB are transmitted.

For one example, the AO-SSB can be a cell-defining SS/PBCH block (CD-SSB) (e.g., the SSB is associated with SIB1 transmission), and the OD-SSB can be a CD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same value of k_SSB.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if REs of one OD-SSB are same as REs of one AO-SSB (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.
For yet another instance, this example can be applicable when AO-SSB is configured for cell global identifier (CGI) reporting, and OD-SSB can be configured on top of the AO-SSB transmission on the same frequency layer, such that the reception and/or measurement based on the AO-SSB or OD-SSB in the CGI reporting procedure can be faster. In addition, when the cell with AO-SSB is configured as a SCell, the OD-SSB can facilitate faster SCell activation.

For another example, the AO-SSB can be a cell-defining SS/PBCH block (CD-SSB) (e.g., the SSB is associated with SIB1 transmission), and the OD-SSB can be a non-cell-defining SS/PBCH block (NCD-SSB) (e.g., the SSB is not associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if REs of one OD-SSB are same as REs of one AO-SSB (e.g., the REs are determined by the configuration of OB-SSB and AO-SSB, respectively). For one further implementation of this instance, the UE (e.g., the UE 116) can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For yet another example, the AO-SSB can be a non-cell-defining SS/PBCH block (NCD-SSB) (e.g., the SSB is not associated with SIB1 transmission), and the OD-SSB can be a cell-defining SS/PBCH block (CD-SSB) (e.g., the SSB is associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if REs of one OD-SSB are same as REs of one AO-SSB (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For yet another example, the AO-SSB can be a non-cell-defining SS/PBCH block (NCD-SSB) (e.g., the SSB is not associated with SIB1 transmission), and the OD-SSB can be a NCD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6},ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when k_SSB is the same for the AO-SSB and OD-SSB.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if REs of one OD-SSB are same as REs of one AO-SSB (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.
For yet another instance, this example can be applicable when AO-SSB is configured for measurement purpose, and OD-SSB can be configured on top of the AO-SSB transmission on the same frequency layer, such that the measurement based on the AO-SSB or OD-SSB in the CGI reporting procedure can be faster and/or more reliable. In addition, when the cell with AO-SSB is configured as a SCell, the OD-SSB can facilitate faster SCell activation.

FIG. 7 illustrates examples of OD-SSBs and AO-SSBs 700 according to embodiments of the present disclosure. For example, OD-SSBs and AO-SSBs 700 can be received by any of the UEs 111-116 of FIG. 1, such as the UE 113. This example is for illustration only and other embodiments can be used without departing from the scope of the present disclosure.

In one embodiment, center frequencies of always-on SS/PBCH block (AO-SSB) can be located on a first frequency layer, and on-demand SSB (OD-SSB) can be located on a second frequency layer, wherein the first frequency layer and the second frequency layer correspond to different synchronization raster entries (e.g., a synchronization raster entry can be defined by a global synchronization channel number, GSCN).

An illustration of the embodiment is shown in FIG. 7.

For one example, for this embodiment, the configuration of OD-SSB may include a parameter indicating the frequency location of the OD-SSB, and it can be a separate parameter from the one indicating the frequency location of the AO-SSB. For this example, the parameter indicating the frequency location of the OD-SSB corresponds to a synchronization raster entry (e.g., defined by a global synchronization channel number, GSCN).

For another example, for this embodiment, the AO-SSB and OD-SSB have the same case of the SSB pattern in a half frame (e.g., predefined starting symbols for candidate SSB in a half frame).

For yet another example, for this embodiment, the AO-SSB and OD-SSB are located within a same BWP (e.g., active BWP), e.g., frequency resources of AO-SSB and OD-SSB are both included in the BWP. For one further evaluation, the frequency resources of AO-SSB and OD-SSB do not overlap.

For yet another example, for this embodiment, a UE is not required to measure both AO-SSB and OD-SSB, wherein the measurement can be at least one of a layer 1 measurement or a layer 3 measurement.

For yet another example, for this embodiment, a UE is not required to receive both AO-SSB and OD-SSB. For a further evaluation, the example can be applicable when a AO-SSB and a OD-SSB are in the same slot or in the same half frame.

For yet another example, for this embodiment, a UE (e.g., the UE 116) can report a UE capability on whether to support AO-SSB and OD-SSB with different center frequency locations.

For one example, the AO-SSB can be a cell-defining SS/PBCH block (CD-SSB) (e.g., the SSB is associated with SIB1 transmission), and the OD-SSB can be a CD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same value of k_SSB.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or resource blocks (RBs)) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For another example, the AO-SSB can be a cell-defining SS/PBCH block (CD-SSB) (e.g., the SSB is associated with SIB1 transmission), and the OD-SSB can be a non-cell-defining SS/PBCH block (NCD-SSB) (e.g., the SSB is not associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the information for the CD-SSB indicated by controlResourceSetZero, searchSpaceZero, and k_SSB using the OD-SSB is the AO-SSB.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.
For yet another instance, this example can be applicable when AO-SSB is located on sync raster (e.g., for initial cell search), and OD-SSB can be configured on top of the AO-SSB transmission on different frequency layer, such that when the cell with AO-SSB is configured as a SCell, the OD-SSB can facilitate faster SCell activation.

For yet another example, the AO-SSB can be a non-cell-defining SS/PBCH block (NCD-SSB) (e.g., the SSB is not associated with SIB1 transmission), and the OD-SSB can be a cell-defining SS/PBCH block (CD-SSB) (e.g., the SSB is associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the information for the CD-SSB indicated by controlResourceSetZero, searchSpaceZero, and k_SSB using the AO-SSB is the OD-SSB.
For yet another instance, the example can be applicable when the AO-SSB and OD-SSB have the same case of the SSB pattern in a half frame.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE (e.g., the UE 116) can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For yet another example, the AO-SSB can be a non-cell-defining SS/PBCH block (NCD-SSB) (e.g., the SSB is not associated with SIB1 transmission), and the OD-SSB can be a NCD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the information for the CD-SSB indicated by controlResourceSetZero, searchSpaceZero, and k_SSB using the AO-SSB and the OD-SSB are consistent.
For yet another instance, the example can be applicable when the AO-SSB and OD-SSB have the same case of the SSB pattern in a half frame.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.
For yet another instance, this example can be applicable when AO-SSB is located on sync raster, and OD-SSB can be configured on top of the AO-SSB transmission on different frequency layer, such that when the cell with AO-SSB is configured as a SCell, the OD-SSB can facilitate faster SCell activation.

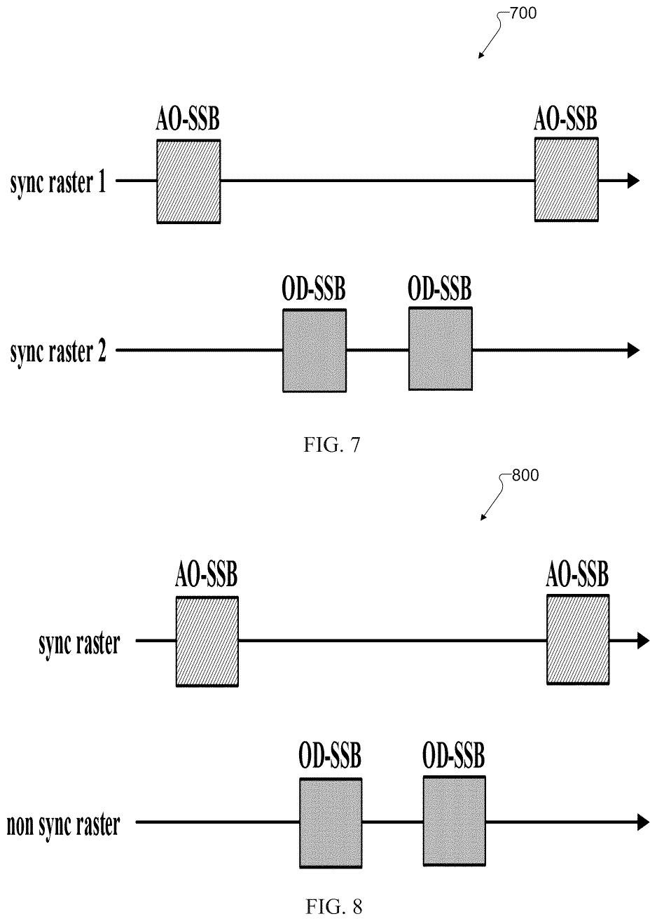

FIG. 8 illustrates examples of OD-SSBs and AO-SSBs 800 according to embodiments of the present disclosure. For example, OD-SSBs and AO-SSBs 800 can be received by any of the UEs 111-116 of FIG. 1, such as the UE 114. This example is for illustration only and other embodiments can be used without departing from the scope of the present disclosure.

In one embodiment, center frequencies of always-on SS/PBCH block (AO-SSB) can be located on a first frequency layer, and on-demand SSB (OD-SSB) can be located on a second frequency layer, wherein the first frequency layer corresponds to a synchronization raster entry (e.g., a synchronization raster entry can be defined by a global synchronization channel number, GSCN) and the second frequency layer does not correspond to a synchronization raster entry.

An illustration of the embodiment is shown in FIG. 8.

For one example, for this embodiment, the configuration of OD-SSB may include a parameter indicating the frequency location of the OD-SSB, and it can be a separate parameter from the one indicating the frequency location of the AO-SSB. For this example, the parameter indicating the frequency location of the OD-SSB does not correspond to a synchronization raster entry (e.g., a synchronization raster entry is defined by a global synchronization channel number, GSCN).

For another example, for this embodiment, the AO-SSB and OD-SSB have the same case of the SSB pattern in a half frame (e.g., predefined starting symbols for candidate SSB in a half frame).

For yet another example, for this embodiment, the AO-SSB and OD-SSB are located within a same BWP (e.g., active BWP), e.g., frequency resources of AO-SSB and OD-SSB are both included in the BWP. For one further evaluation, the frequency resources of AO-SSB and OD-SSB do not overlap.

For yet another example, for this embodiment, a UE is not required to measure both AO-SSB and OD-SSB, wherein the measurement can be at least one of a layer 1 measurement or a layer 3 measurement.

For yet another example, for this embodiment, a UE is not required to receive both AO-SSB and OD-SSB. For a further evaluation, the example can be applicable when a AO-SSB and a OD-SSB are in the same slot or in the same half frame.

For yet another example, for this embodiment, a UE can report a UE capability on whether to support AO-SSB and OD-SSB with different center frequency locations.

For one example, the AO-SSB can be a cell-defining SS/PBCH block (CD-SSB) (e.g., the SSB is associated with SIB1 transmission), and the OD-SSB can be a CD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same value of k_SSB.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE (e.g., the UE 116) can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For another example, the AO-SSB can be a cell-defining SS/PBCH block (CD-SSB) (e.g., the SSB is associated with SIB1 transmission), and the OD-SSB can be a non-cell-defining SS/PBCH block (NCD-SSB) (e.g., the SSB is not associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the k_SSB values for the AO-SSB and OD-SSB are different.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For yet another example, the AO-SSB can be a non-cell-defining SS/PBCH block (NCD-SSB) (e.g., the SSB is not associated with SIB1 transmission), and the OD-SSB can be a cell-defining SS/PBCH block (CD-SSB) (e.g., the SSB is associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the k_SSB values for the AO-SSB and OD-SSB are different.
For yet another instance, the example can be applicable when the AO-SSB and OD-SSB have the same case of the SSB pattern in a half frame.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For yet another example, the AO-SSB can be a non-cell-defining SS/PBCH block (NCD-SSB) (e.g., the SSB is not associated with SIB1 transmission), and the OD-SSB can be a NCD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same case of the SSB pattern in a half frame.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE (e.g., the UE 116) can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

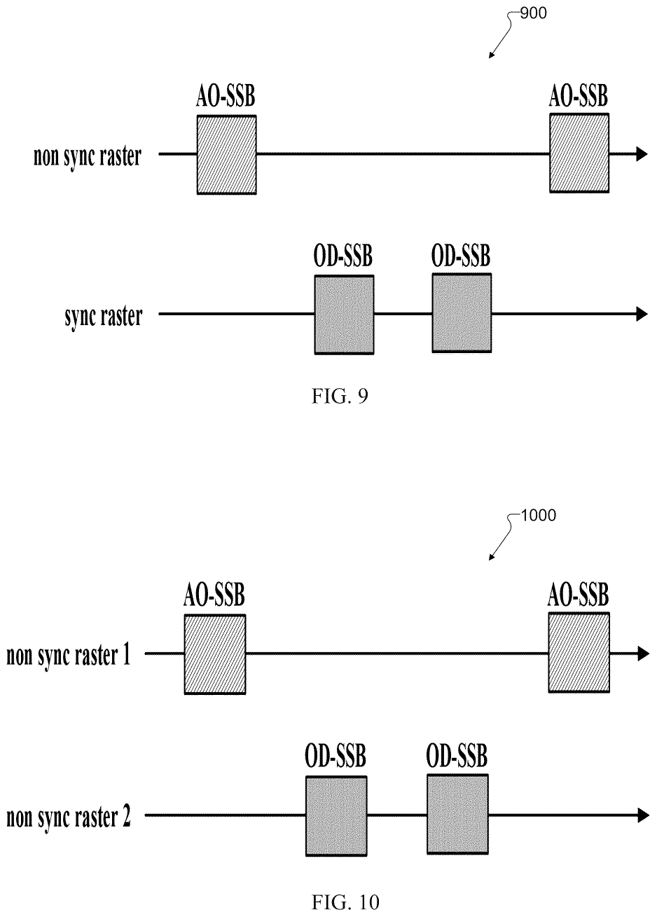

FIG. 9 illustrates examples of OD-SSBs and AO-SSBs 900 according to embodiments of the present disclosure. For example, OD-SSBs and AO-SSBs 900 can be received by any of the UEs 111-116 of FIG. 1, such as the UE 115. This example is for illustration only and other embodiments can be used without departing from the scope of the present disclosure.

In one embodiment, center frequencies of always-on SS/PBCH block (AO-SSB) can be located on a first frequency layer, and on-demand SSB (OD-SSB) can be located on a second frequency layer, wherein the first frequency layer does not correspond to a synchronization raster entry (e.g., a synchronization raster entry can be defined by a global synchronization channel number, GSCN) and the second frequency layer corresponds to a synchronization raster entry.

An illustration of the embodiment is shown in FIG. 9.

For one example, for this embodiment, the configuration of OD-SSB may include a parameter indicating the frequency location of the OD-SSB, and it can be a separate parameter from the one indicating the frequency location of the AO-SSB. For this example, the parameter indicating the frequency location of the OD-SSB corresponds to a synchronization raster entry (e.g., a synchronization raster entry is defined by a global synchronization channel number, GSCN).

For another example, for this embodiment, the AO-SSB and OD-SSB have the same case of the SSB pattern in a half frame (e.g., predefined starting symbols for candidate SSB in a half frame).

For yet another example, for this embodiment, the AO-SSB and OD-SSB are located within a same BWP (e.g., active BWP), e.g., frequency resources of AO-SSB and OD-SSB are both included in the BWP. For one further evaluation, the frequency resources of AO-SSB and OD-SSB do not overlap.

For yet another example, for this embodiment, a UE is not required to measure both AO-SSB and OD-SSB, wherein the measurement can be at least one of a layer 1 measurement or a layer 3 measurement.

For yet another example, for this embodiment, a UE is not required to receive both AO-SSB and OD-SSB. For a further evaluation, the example can be applicable when a AO-SSB and a OD-SSB are in the same slot or in the same half frame.

For yet another example, for this embodiment, a UE can report a UE capability on whether to support AO-SSB and OD-SSB with different center frequency locations.

For one example, the AO-SSB can be a cell-defining SS/PBCH block (CD-SSB) (e.g., the SSB is associated with SIB1 transmission), and the OD-SSB can be a CD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same value of k_SSB.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For another example, the AO-SSB can be a cell-defining SS/PBCH block (CD-SSB) (e.g., the SSB is associated with SIB1 transmission), and the OD-SSB can be a non-cell-defining SS/PBCH block (NCD-SSB) (e.g., the SSB is not associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the k_SSB values for the AO-SSB and OD-SSB are different.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE (e.g., the UE 116) can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.
For yet another instance, this example can be applicable when AO-SSB is located on sync raster (e.g., for initial cell search), and OD-SSB can be configured on top of the AO-SSB transmission but on a different sync raster, such that the OD-SSB can indicate the frequency location of the AO-SSB to facilitate fast initial cell search. In addition, when the cell with AO-SSB is configured as a SCell, the OD-SSB can facilitate faster SCell activation.

For yet another example, the AO-SSB can be a non-cell-defining SS/PBCH block (NCD-SSB) (e.g., the SSB is not associated with SIB1 transmission), and the OD-SSB can be a cell-defining SS/PBCH block (CD-SSB) (e.g., the SSB is associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the k_SSB values for the AO-SSB and OD-SSB are different.
For yet another instance, the example can be applicable when the AO-SSB and OD-SSB have the same case of the SSB pattern in a half frame.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For yet another example, the AO-SSB can be a non-cell-defining SS/PBCH block (NCD-SSB) (e.g., the SSB is not associated with SIB1 transmission), and the OD-SSB can be a NCD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same case of the SSB pattern in a half frame.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

FIG. 10 illustrates examples of OD-SSBs and AO-SSBs 1000 according to embodiments of the present disclosure. For example, OD-SSBs and AO-SSBs 1000 can be received by any of the UEs 111-116 of FIG. 1, such as the UE 116. This example is for illustration only and other embodiments can be used without departing from the scope of the present disclosure.

In one embodiment, center frequencies of always-on SS/PBCH block (AO-SSB) can be located on a first frequency layer, and on-demand SSB (OD-SSB) can be located on a second frequency layer, wherein neither of the first frequency layer or the second frequency layer corresponds to a synchronization raster entry (e.g., a synchronization raster entry can be defined by a global synchronization channel number, GSCN).

An illustration of the embodiment is shown in FIG. 10.

For one example, for this embodiment, the configuration of OD-SSB may include a parameter indicating the frequency location of the OD-SSB, and it can be a separate parameter from the one indicating the frequency location of the AO-SSB. For this example, the parameter indicating the frequency location of the OD-SSB does not correspond to a synchronization raster entry (e.g., a synchronization raster entry is defined by a global synchronization channel number, GSCN).

For another example, for this embodiment, the AO-SSB and OD-SSB have the same case of the SSB pattern in a half frame (e.g., predefined starting symbols for candidate SSB in a half frame).

For yet another example, for this embodiment, the AO-SSB and OD-SSB are located within a same BWP (e.g., active BWP), e.g., frequency resources of AO-SSB and OD-SSB are both included in the BWP. For one further evaluation, the frequency resources of AO-SSB and OD-SSB do not overlap.

For yet another example, for this embodiment, a UE is not required to measure both AO-SSB and OD-SSB, wherein the measurement can be at least one of a layer 1 measurement or a layer 3 measurement.

For yet another example, for this embodiment, a UE (e.g., the UE 116) is not required to receive both AO-SSB and OD-SSB. For a further evaluation, the example can be applicable when a AO-SSB and a OD-SSB are in the same slot or in the same half frame.

For yet another example, for this embodiment, a UE can report a UE capability on whether to support AO-SSB and OD-SSB with different center frequency locations.

For one example, the AO-SSB can be a cell-defining SS/PBCH block (CD-SSB) (e.g., the SSB is associated with SIB1 transmission), and the OD-SSB can be a CD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same value of k_SSB.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For another example, the AO-SSB can be a cell-defining SS/PBCH block (CD-SSB) (e.g., the SSB is associated with SIB1 transmission), and the OD-SSB can be a non-cell-defining SS/PBCH block (NCD-SSB) (e.g., the SSB is not associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the k_SSB values for the AO-SSB and OD-SSB are different.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.
For yet another instance, this example can be applicable when AO-SSB is configured for CGI reporting, and OD-SSB can be configured on top of the AO-SSB transmission on different frequency layer, such that when the cell with AO-SSB is configured as a SCell, the OD-SSB can facilitate faster SCell activation.

For yet another example, the AO-SSB can be a non-cell-defining SS/PBCH block (NCD-SSB) (e.g., the SSB is not associated with SIB1 transmission), and the OD-SSB can be a cell-defining SS/PBCH block (CD-SSB) (e.g., the SSB is associated with SIB1 transmission).
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the k_SSB values for the AO-SSB and OD-SSB are different.
For yet another instance, the example can be applicable when the AO-SSB and OD-SSB have the same case of the SSB pattern in a half frame.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE (e.g., the UE 116) can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.

For yet another example, the AO-SSB can be a non-cell-defining SS/PBCH block (NCD-SSB) (e.g., the SSB is not associated with SIB1 transmission), and the OD-SSB can be a NCD-SSB.
For one instance, the example can be applicable when the AO-SSB and OD-SSB have the same physical cell ID (e.g., OD-SSB uses the same configuration of physical cell ID as the AO-SSB, such as provided by RRC parameter physicalCellId).
For another instance, the example can be applicable when the AO-SSB and OD-SSB have different physical cell ID (e.g., OD-SSB uses a different configuration of physical cell ID from the AO-SSB, such as provided by two different RRC parameters physicalCellId).
For yet another instance, the example can be applicable when the AO-SSB and OD-SSB have the same at least one field in MIB or PBCH payload (e.g., when they are in the same TTI of MIB), such as at least one of subCarrierSpacingCommon, ssb-SubcarrierOffset, dmrs-TypeA-Position, controlResourceSetZero, searchSpaceZero, cellBarred, intraFreqSelection, or spare. For one further evaluation, the PBCH payload (e.g., other than SFN (e.g., systemFrameNumber, ā_{Ā}, ā_{Ā+1}, ā_{Ā+2}, ā_{Ā+3}), half frame index (e.g., ā_{Ā+4}), or (candidate) SSB index (or part of (candidate) SSB index, such as ā_{Ā+5}, ā_{Ā+6}, ā_{Ā+7})) is same for AO-SSB and OD-SSB. For another further evaluation, the PBCH payload (e.g., other than other than SFN (systemFrameNumber, ā_{Ā}, ā_{Ā+1}, ā_{Ā+2}, ā_{Ā+3}), or half frame index (e.g., ā_{Ā+4})) is same for AO-SSB and OD-SSB with same (candidate) SSB index. For yet another instance, the example can be applicable when the AO-SSB and OD-SSB have the same case of the SSB pattern in a half frame.
For yet another instance, the example can be applicable when the AO-SSB and OD-SSB have the same actually transmitted SSB (e.g., OD-SSB uses the same configuration of actually transmitted SSB as the AO-SSB, such as provided by RRC parameter ssb-PositionsInBurst).
For yet another instance, the example can be applicable when the actually transmitted SSB for OD-SSB is the same or a subset of actually transmitted SSB for OD-SSB (e.g., provided by two RRC parameters ssb-PositionsInBurst, respectively).
For yet another instance, the example can be applicable when the AO-SSB and OD-SSB have the same transmission power, e.g., OD-SSB uses the same configuration of transmission power as the AO-SSB such as provided by RRC parameter ss-PBCH-BlockPower, or the configuration for the transmission power of OD-SSB is absent, or the configuration for an offset between the transmission power of OD-SSB and the transmission power of AO-SSB is determined as 0.
For yet another instance, the example can be applicable when the AO-SSB and OD-SSB have different or separate RRC parameters for the transmission power (e.g., ss-PBCH-BlockPower).
For yet another instance, the example can be applicable when the AO-SSB and OD-SSB have the same subcarrier spacing (e.g., ssb-SubcarrierSpacing).
For yet another instance, the example can be applicable when the periodicity of AO-SSB is no less than or larger than a threshold, e.g., 20 ms.
For yet another instance, the example can be applicable when the periodicity of AO-SSB is no less than or larger than the periodicity of OD-SSB.
For yet another instance, the example can be applicable if half frames including OD-SSB burst and half frames including AO-SSB burst do not overlap (e.g., the half frames are determined by the configuration of OD-SSB and AO-SSB, respectively).
For yet another instance, the example can be applicable if half frames including OD-SSB burst and half frames including AO-SSB burst are the same (e.g., the half frames are determined by the configuration of OD-SSB and AO-SSB, respectively).
For yet another instance, the example can be applicable if a first number of consecutive slots including one OD-SSB burst and a second number of consecutive slots including one AO-SSB burst do not overlap (e.g., the first and second number of consecutive slots are determined by the configuration of OB-SSB and AO-SSB, respectively).
For yet another instance, the example can be applicable if slots including on-demand SSB and slots including AO-SSB do not overlap (e.g., the slots are determined by the configuration of OB-SSB and AO-SSB, respectively).
For yet another instance, the example can be applicable if slots including on-demand SSB and slots including AO-SSB are the same (e.g., the slots are determined by the configuration of OB-SSB and AO-SSB, respectively).
For yet another instance, the example can be applicable if OFDM symbols including on-demand SSB and OFDM symbols including AO-SSB do not overlap (e.g., the OFDM symbols are determined by the configuration of OB-SSB and AO-SSB, respectively).
For yet another instance, the example can be applicable if OFDM symbols including on-demand SSB and OFDM symbols including AO-SSB are the same (e.g., the OFDM symbols are determined by the configuration of OB-SSB and AO-SSB, respectively).
For yet another instance, the example can be applicable if any RE in OD-SSB and any RE in AO-SSB do not overlap (e.g., the REs are determined by the configuration of OB-SSB and AO-SSB, respectively).
For yet another instance, the example can be applicable if frequency resources (e.g., subcarriers or RBs) of OD-SSB and frequency resources (e.g., subcarriers or RBs) of AO-SSB do not overlap (e.g., the frequency resources (e.g., subcarriers or RBs) are determined by the configuration of OB-SSB and AO-SSB, respectively).
For yet another instance, the example can be applicable if at least one RE in OD-SSB and at least one RE in AO-SSB overlap (e.g., the REs are determined by the configuration of OB-SSB and AO-SSB, respectively). For one further implementation of this instance, the UE can assume the BS transmits the AO-SSB and drops the transmission of OD-SSB. For another further implementation of this instance, the UE can assume the BS transmits the OD-SSB and drops the transmission of AO-SSB. For yet another further implementation of this instance, the UE can assume the BS transmits the SSB from OD-SSB and AO-SSB with larger periodicity. For yet another further implementation of this instance, the UE can assume the BS transmits the SSB from OD-SSB and AO-SSB with smaller periodicity.
For yet another instance, the example can be applicable if a half frame including one OD-SSB burst is same as a half frame including one AO-SSB burst (e.g., the half frames are determined by the configuration of OB-SSB and AO-SSB, respectively). For one further implementation of this instance, the UE can assume the BS transmits the AO-SSB and drops the transmission of OD-SSB in the half frame. For another further implementation of this instance, the UE can assume the BS transmits the OD-SSB and drops the transmission of AO-SSB in the half frame. For yet another further implementation of this instance, the UE can assume the BS transmits the SSB from OD-SSB and AO-SSB with larger periodicity in the half frame. For yet another further implementation of this instance, the UE can assume the BS transmits the SSB from OD-SSB and AO-SSB with smaller periodicity in the half frame.
For yet another instance, this example can be applicable when AO-SSB is located not on sync raster (e.g., for measurement purpose), and OD-SSB can be configured on top of the AO-SSB transmission on different frequency layer, such that when the cell with AO-SSB is configured as a SCell, the OD-SSB can facilitate faster SCell activation.

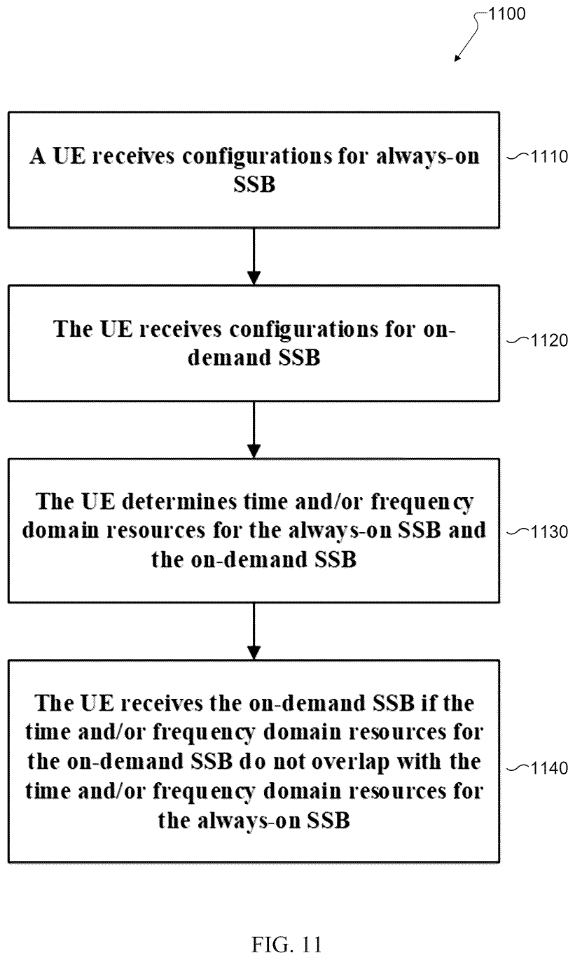

FIG. 11 illustrates a flowchart of an example UE procedure 1100 for receiving OD-SSB according to embodiments of the present disclosure. For example, procedure 1100 can be performed by the UE 116 of FIG. 3. This example is for illustration only and other embodiments can be used without departing from the scope of the present disclosure.

The procedure begins in 1110, a UE receives configurations for always-on SSB. In 1120, the UE receives configurations for on-demand SSB. In 1130, the UE determines time and/or frequency domain resources for the always-on SSB and the on-demand SSB. In 1140, the UE receives the on-demand SSB if the time and/or frequency domain resources for the on-demand SSB do not overlap with the time and/or frequency resources for the always-on SSB.

In one embodiment, an example UE procedure for receiving on-demand SSB is illustrated in FIG. 11.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a set of higher layer parameters; and
a processor operably coupled to the transceiver, the processor configured to:
determine, based on the set of higher layer parameters, configurations for first and second sets of synchronization signals and physical broadcast channel (SS/PBCH) blocks;
identify, based on the configurations, a first frequency location for the first set of SS/PBCH blocks and a second frequency location for the second set of SS/PBCH blocks; and
determine that:
the first set of SS/PBCH blocks is associated with a system information block 1 (SIB1);
the first frequency location corresponds to a global synchronization channel number (GSCN) of a first synchronization raster entry from a set of synchronization raster entries;
the second set of SS/PBCH blocks is not associated with the SIB1;
the second frequency location is different from the first frequency location; and
the second frequency location does not correspond to a GSCN of any synchronization raster entry from the set of synchronization raster entries,
wherein the transceiver is further configured to receive the first and second sets of SS/PBCH blocks.

2. The UE of claim 1, wherein the first and second sets of SS/PBCH blocks are on a secondary cell (SCell).

3. The UE of claim 1, wherein:
the first set of SS/PBCH blocks is transmitted periodically; and
the second set of SS/PBCH blocks is transmitted based on downlink indications.

4. The UE of claim 1, wherein the processor is further configured to determine that the first and second sets of SS/PBCH blocks are within a same bandwidth part (BWP).

5. The UE of claim 1, wherein the processor is further configured to determine that frequency resources of the first set of SS/PBCH blocks do not overlap with frequency resources of the second set of SS/PBCH blocks.

6. The UE of claim 1, wherein the processor is further configured to identify, based on the configurations,
a same physical cell identity for the first and second sets of SS/PBCH blocks;
a same transmission power for the first and second sets of SS/PBCH blocks; and
a same subcarrier spacing for the first and second sets of SS/PBCH blocks.

7. The UE of claim 1, wherein the processor is further configured to:
identify, based on the configurations, a first set of transmitted SS/PBCH block indexes for the first set of SS/PBCH blocks and a second set of transmitted SS/PBCH block indexes for the second set of SS/PBCH blocks; and
determine that the second set of transmitted SS/PBCH block indexes is the same as or a subset of the first set of transmitted SS/PBCH block indexes.

8. A base station (BS) in a wireless communication system, the BS comprising:
a processor configured to:
determine configurations for first and second sets of synchronization signals and physical broadcast channel (SS/PBCH) blocks, wherein the configurations include a first frequency location for the first set of SS/PBCH blocks and a second frequency location for the second set of SS/PBCH blocks; and
determine that:
the first set of SS/PBCH blocks is associated with a system information block 1 (SIB1);
the first frequency location corresponds to a global synchronization channel number (GSCN) of a first synchronization raster entry from a set of synchronization raster entries;
the second set of SS/PBCH blocks is not associated with the SIB1;
the second frequency location is different from the first frequency location; and
the second frequency location does not correspond to a GSCN of any synchronization raster entry from the set of synchronization raster entries; and
a transceiver operably coupled to the processor, the transceiver configured to:
transmit a set of higher layer parameters including the configurations; and
transmit the first and second sets of SS/PBCH blocks.

9. The BS of claim 8, wherein the first and second sets of SS/PBCH blocks are on a secondary cell (SCell).

10. The BS of claim 8, wherein:
the first set of SS/PBCH blocks is transmitted periodically; and
the second set of SS/PBCH blocks is transmitted based on downlink indications.

11. The BS of claim 8, wherein the processor is further configured to determine that the first and second sets of SS/PBCH blocks are within a same bandwidth part (BWP).

12. The BS of claim 8, wherein the processor is further configured to determine that frequency resources of the first set of SS/PBCH blocks do not overlap with frequency resources of the second set of SS/PBCH blocks.

13. The BS of claim 8, wherein the processor is further configured to determine:
a same physical cell identity for the first and second sets of SS/PBCH blocks;
a same transmission power for the first and second sets of SS/PBCH blocks; and
a same subcarrier spacing for the first and second sets of SS/PBCH blocks.

14. The BS of claim 8, wherein:
the processor is further configured to determine a first set of transmitted SS/PBCH block indexes for the first set of SS/PBCH blocks and a second set of transmitted SS/PBCH block indexes for the second set of SS/PBCH blocks, and
the second set of transmitted SS/PBCH block indexes is the same as or a subset of the first set of transmitted SS/PBCH block indexes.

15. A method of a user equipment (UE) in a wireless communication system, the method comprising:
receiving a set of higher layer parameters;
determining, based on the set of higher layer parameters, configurations for first and second sets of synchronization signals and physical broadcast channel (SS/PBCH) blocks;
identifying, based on the configurations, a first frequency location for the first set of SS/PBCH blocks and a second frequency location for the second set of SS/PBCH blocks;
determining that:
the first set of SS/PBCH blocks is associated with a system information block 1 (SIB1);
the first frequency location corresponds to a global synchronization channel number (GSCN) of a first synchronization raster entry from a set of synchronization raster entries;
the second set of SS/PBCH blocks is not associated with the SIB1;
the second frequency location is different from the first frequency location; and
the second frequency location does not correspond to a GSCN of any synchronization raster entry from the set of synchronization raster entries; and
receiving the first and second sets of SS/PBCH blocks.

16. The method of claim 15, wherein the first and second sets of SS/PBCH blocks are on a secondary cell (SCell).

17. The method of claim 15, wherein:
the first set of SS/PBCH blocks is transmitted periodically; and
the second set of SS/PBCH blocks is transmitted based on downlink indications.

18. The method of claim 15, further comprising:
determine that the first and second sets of SS/PBCH blocks are within a same bandwidth part (BWP); and
determine that frequency resources of the first set of SS/PBCH blocks do not overlap with frequency resources of the second set of SS/PBCH blocks.

19. The method of claim 15, further comprising:
identifying, based on the configurations:
a same physical cell identity for the first and second sets of SS/PBCH blocks;
a same transmission power for the first and second sets of SS/PBCH blocks; and
a same subcarrier spacing for the first and second sets of SS/PBCH blocks.

20. The method of claim 15, further comprising:
identifying, based on the configurations, a first set of transmitted SS/PBCH block indexes for the first set of SS/PBCH blocks, and a second set of transmitted SS/PBCH block indexes for the second set of SS/PBCH blocks; and
determining that the second set of transmitted SS/PBCH block indexes is the same as or a subset of the first set of transmitted SS/PBCH block indexes.
